(19) United States
(12) Patent Application Publication
(10) Pub. No.: US 2004/0257224 A1
(43) Pub. Date: Dec. 23, 2004

(54) Electronic security system for monitoring and recording activity and data relating to institutions and clients thereof

(75) Inventor: James M. Sajkowsky, Pennington, NJ (US)

Correspondence Address: J. Kevin Grogan, Esq., McCormick, Paulding & Huber LLP, 185 Asylum Street, City Place II, Hartford, CT, 06103, US

(73) Assignee: UNITED SECURITY APPLICATIONS ID, INC., East Windsor, NJ

(21) Appl. No.: 10/871,264

(22) Filed: Jun. 17, 2004

Related U.S. Application Data
(60) Provisional application No. 60/479,127, filed on Jun. 17, 2003.

(51) Int. Cl. G08B 1/08

(52) U.S. Cl. 340/539.13; 340/825.49

(57) ABSTRACT

A tracking system for use in identifying individuals of a group, each of the individuals having an associated data set indicative of the identity of those individuals, includes an electromagnetic identification apparatus configured with each of the individuals for providing an electromagnetic identification signal indicative of the content data set of that apparatus; a writer for use in encoding the electromagnetic identification signals with signals indicative of the individual onto the electromagnetic identification apparatus; a controller for receiving the encoded signals and for storing the encoded signals in a master database storage apparatus; and a reader remotely positioned from the controller and configured for communicating with the electromagnetic identification apparatus and receiving the encoded signals therefrom corresponding to the content data signal set, the reader also for providing the controller with signals indicative of the same.

### CROSS-REFERENCE TO RELATED APPLICATIONS

This application claims the benefit of U.S. Provisional Application No. 60/479,127, filed Jun. 17, 2003, entitled “Electronic Security System For Monitoring and Recording Activity and Data Relating to Persons and Goods”; and further relates to a co-pending application entitled “Electronic Security System For Monitoring and Recording Activity and Data Relating to Persons” (Attorney Docket No. 5264-0002-1) filed concurrently herewith; and further relates to a co-pending application entitled “Electronic Security System For Monitoring and Recording Activity and Data Relating to Cargo” (Attorney Docket No. 5264-0002-2) filed concurrently herewith, all of the fore-mentioned applications being hereby incorporated by reference in their entireties.

### BACKGROUND OF THE INVENTION

1. Field of the Invention

The present invention relates to systems and methods of electronically monitoring and recording data and activity in institutions, and more particularly to a system and method for recording data relevant to individuals in hospitals, prisons, or other institutions as the data pertaining to those individuals changes and as they move about the confines of that institution.

2. Description of Related Art

The need for more security in institutional facilities has been enhanced since the massive breach of security that occurred on Sep. 11, 2001. This need is particularly acute in those institutions where there is an adversarial relationship between the authorities and management of the institution such as in the case of prisons, as well as those situations where an individual may or may not be fully capable to care for themselves or is in the course of treatment for medical or psychological conditions. This would be the case in hospitals as well as mental institutions.

Previously, computer systems have been introduced to the management of these institutions, primarily in hospital settings, for entering data that relates to individual patients on a central computer system. In the past, the patients were given a wrist band that contained all the information that identified that individual, e.g., name, ward, room, etc. Consequently, if the individual was either uncooperative, as in the case of a prison, or was rendered unable to respond, authorities and personnel in the institution could quickly identify that individual (either manually or by computer) and contact the central computer system to ascertain the relevant information as to that individual.

This particular configuration is deficient in many areas. It cannot provide for real-time tracking of patients and/or prisoners. It cannot provide any record of the movements of individuals throughout the institution, nor can it generate an alarm if there is an individual in a particular location where they are not authorized to be or where an individual is spending an inordinate amount of time. For example, existing systems do not account for prisoners who are in a restricted area or a patient who has spent to much time in a restroom or bath perhaps, the latter possibly being indicative of a medical problem.

As is well known, there has been substantial development in the technology of monitoring and maintaining control over goods in inventory and in transit. However, the prior art system for management of individuals in institutions simply is not capable of interfacing or otherwise incorporating any of this technology. Such technology is primarily inherently limited to the use of simple paper or tape wristband technology.

What is needed is a system for monitoring and recording activity and data relating to the disposition and movements of individuals in an institution while maintaining the security of the individuals and the integrity of the data itself.

### SUMMARY OF THE INVENTION

An object of the present invention is to provide a system and method for recording activity and data relating to individuals in an institution that allows for real time tracking and inventory control.

Another object of the present invention is to provide a system and method of the foregoing type which is capable of providing full personal data locally on an institutionalized individual.

Still another object of the present invention is to provide a system and method of the foregoing type wherein a permanent record can be made of locations and movement of individuals in an institution.

In one aspect, the present invention is directed to a tracking system for use in identifying individuals of a group, each of the individuals having an associated data set indicative of the identity of those individuals. Such a system includes an electromagnetic identification apparatus configured with each of the individuals for providing an electromagnetic identification signal indicative of the content data set of that apparatus; a writer for use in encoding the electromagnetic identification signals with signals indicative of the individual onto the electromagnetic identification apparatus; a controller for receiving the encoded signals and for storing the encoded signals in a master database storage apparatus; and a reader remotely positioned from the controller and configured for communicating with the electromagnetic identification apparatus and receiving the encoded signals therefrom corresponding to the content data signal set, the reader also for providing the controller with signals indicative of the same.

One of the advantages of the present invention is that it allows for localized reading of the contents of the electromagnetic identification tag. This allows for nurses, for example, to quickly poll the identification tag contents to determine the identity of an individual, as well as whether there are any particular restrictions on diet, medicine, or the like relating to that individual. The present system does not rely solely on a single solitary source of data for those situations where connection to the central data system may be impaired or not possible from that location.

### BRIEF DESCRIPTION OF THE DRAWINGS

FIG. 1 is a schematic diagram of an electronic identification system for applicable to the monitoring of individuals and management of data pertaining thereto in an institutional-type setting.

FIG. 2 is a schematic diagram of the system of FIG. 1 in which identifying information is written to a tagging assembly having multiple tags.

FIG. 3 is a perspective view of a radio frequency tag capable of being utilized with the electronic identification system of the present invention.

FIG. 4 is a schematic diagram of the system of FIG. 1 in which identifying information is read from a tagging assembly having multiple tags.

FIGS. 5 and 6 are perspective views of a handheld reading device capable of being utilized with the electronic identification system of the present invention.

FIG. 7 is a schematic diagram of a transceiver system capable of providing communication through metal walls.

FIG. 8 is a simplified flow diagram illustrating a patient care system using radio frequency identification (RFID).

FIG. 9 is a simplified flow diagram illustrating the relationships between a patient in the patient care system of FIG. 8 and various entities.

### DETAILED DESCRIPTION OF THE PREFERRED EMBODIMENT

An important point of departure of the present invention over the prior art is the incorporation of electromagnetic identification tags, preferably in the form of radio frequency identification (RFID) tags of the type as found in other areas such as cargo tracking and inventory control. This particular technology provides for a small chip type device that can contain all of the relevant information about an individual in an institution. This particular technology also allows for constant updating throughout the term of the individual's stay in the institution and also allows for a local reading of the tag to ascertain that the information is stored on the tag.

One of the important aspects of the present invention is that the electromagnetic identification tags are capable of being polled by a reader that can be located in proximity to the tag to be polled, for example, in the room, hall, or ward in which the tag (as it is associated with the individual) is located. Multiple tags can simultaneously respond from each of the individuals to provide information from each polled tag. This allows an entire institution to be polled periodically to create an institutional map for that particular moment showing the location of the individuals in the institution.

For example, each of the various operational theaters in a hospital, such as the operating room, X-ray facility, physical therapy facility, and the like can have a localized reader that periodically polls for identification tags in a particular vicinity. Cadavers in a teaching hospital or bodies in a morgue can also be tagged for identification and tracking purposes. The information is recorded and then stored in a central processing unit as part of a record.

In addition, certain events can trigger a manual reading of the electromagnetic identification tags. For example, when a patient is brought into an operating room, the RFID tag can be read and updated as the patient enters the operating room and then again he exits the operating room. Consequently, the status of the patient before hand and afterwards, as well as how much time was spent in the operating room, can be obtained. Other information such as treating physicians, people in attendance, etc., can also be noted by the system as it polls the RFID tags for the patients and likewise for the attending physicians and nurses. The present invention also allows for hospital personnel to monitor in real-time the specific parameters for an individual which govern, for example, diet and medicine intake. The electromagnetic identification tag can be polled by a nurse, an attending physician, or any other authorized individual or entity.

This kind of information can be invaluable for hospitals and healthcare institutions that seek to absolutely identify different parameters for a variety of perspectives in addition to conventional treatment protocols. Such perspectives include, but are not limited to, potential liability issues that may depend upon the identities of individuals in attendance at a given time in a particular place, such individuals being capable of providing or verifying testimony later in any kind legal proceeding.

Similarly, it is possible for penal institutions to identify all individuals in a given cell, cellblock, or other facility such as a recreational facility, dining hall, or the like. Moreover, guards and other security personnel can be located and their whereabouts determined precisely with the inclusion of electromagnetic identification tags on badges and the like.

Although the preferred embodiment as described hereinafter is drawn with respect to a patient hospital scenario, it is should be understood that the present invention is applicable to any situation where institutional security and identity of personnel therein becomes important. Other situations include, but are not limited to, the monitoring of patients in asylum settings and the monitoring and/or tracking of inmates in penal institutions or in home-arrest situations. The present invention is also applicable to secure operations such as the handling of radioactive materials, the operation of banks, currency operations, and the like, and for government facilities, medical research facilities, and industrial concerns where security is paramount.

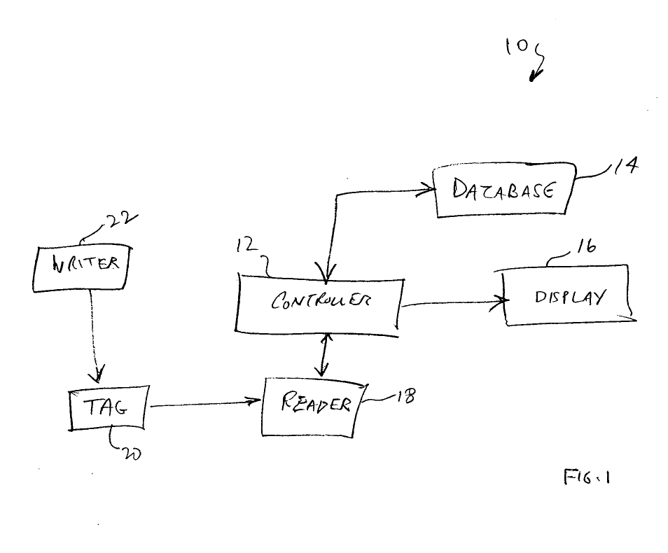

Referring to FIG. 1, the present invention includes an RFID system 10 (hereinafter referred to as “system 10”) having a controller 12, a database 14, a display apparatus 16, a reader 18, an RFID tag apparatus 20, and a write apparatus 22. In a preferred embodiment, the controller 12 is a host computer capable of setting forth the operations as disclosed hereinafter and having sufficient memory so as to provide for the proper processing of the information and its display. The tag apparatus 20 preferably includes a plurality of individual tags that form a tag assembly 20. Each tag may be incorporated into an article that may be worn by an individual being monitored. For example, a tag may be incorporated into the structure of a bracelet, necklace, belt, collar, or the like. Alternatively, the tag may be fixed to an individual to be monitored using implant or piercing methods.

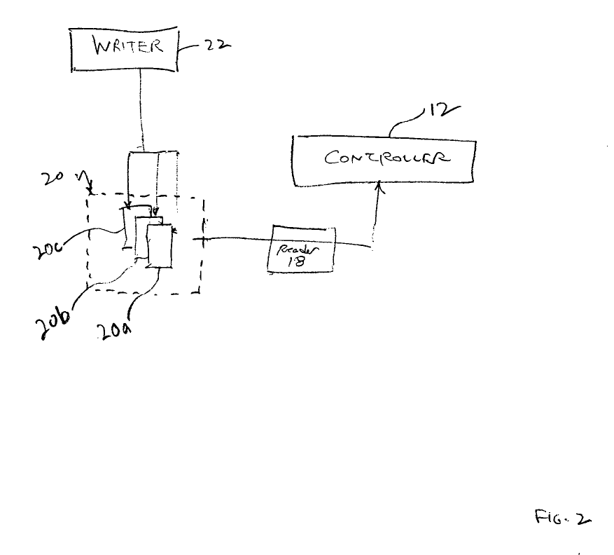

Referring to FIG. 2, the tag is shown as comprising three tags that form the tag assembly 20. Although only three tags are shown at 20a, 20b, and 20c, it should be understood that any number of individual tags may comprise the tag assembly 20.

The individual tags used with the system of the present invention may be passive, active, or a combination thereof. Active tags may include a battery-powered transmitter, which can operate at a range of about 300 feet from the reader 18. These are fairly expensive and may be preferable for use with monitoring prison inmates. Passive tags are more popular because they are typically less than one dollar ($1) in cost. A passive tag has a limited range of less than about ten (10) feet. The mode of operation of the passive tag is significant. In the operation of the passive tag, the reader 18 sends out a radio wave that is received by the antenna on the device. A magnetic field is created from the radio wave to allow the passive tag to draw power to transmit the information stored on the device back to the reader 18 and back to the controller 12. In some configurations, a battery can be used to broadcast back to the reader for longer distances in certain applications. Depending upon the application, either read-writable or read-only RF tags are used.

In the preferred embodiment, the RFID tag is an Intermec 915 megahertz (MHz) Intellitag, which has a passive operation and is EPC (electronic product code) and ISO (International Standards Organization) compliant. Such a tag has a read range of up to about 13 feet and is mountable on an adhesive strip and can further double as a human readable label. The Intermec 915 MHz Intellitag is sized to be mounted on an item of apparel, jewelry, or other wearable item. The initial RFID tag activation may occur at the point of manufacture or at the point at which the tag is attached to the individual to be monitored.

The tag assembly 20 is preferably utilized to store data characteristic of the system of the present invention. Examples of the data that can be stored on an individual tag include, but are not limited to, names, addresses, ward numbers, bed numbers, medications, allergies, dietary restrictions, risk assessment indicators, and the like.

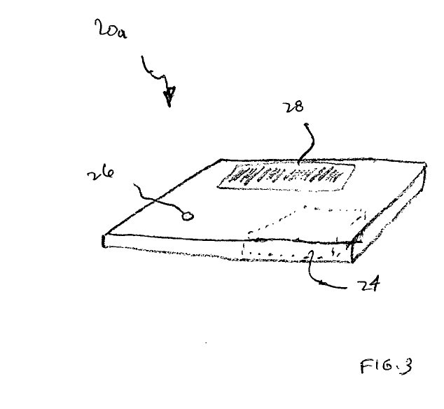

Referring now to FIG. 3, the tag 20a preferably includes a signal device 26, an internal memory chip (not shown), and an identifying code 28 (e.g., a bar code capable of being scanned by a scanning device). Optionally, the tag 20a may include a battery 24, although the preferred device operates without one. If present, however, the life of the battery 24 is greater than about five years, although duty cycle and operating frequency may contribute to shortening the life significantly. The identifying code 28 is preferably unique to each tag to aid in the identification of an individual and the tracking and monitoring of the movement of the individual. Each tag is mountable to the structure of the card using any suitable method such as adhesive compositions, mechanical fasteners, combinations thereof, or the like. The tag may additionally or alternatively incorporated into the card using lamination techniques.

The internal memory chip of the tag 20a typically comprises an EEPROM with 1,024 bits total memory. Byte boundary memory addressing and byte boundary memory lock are used. The communications platform used to receive data from the polled tags is preferably an anti-collision protocol binary tree-type anti-collision algorithm.

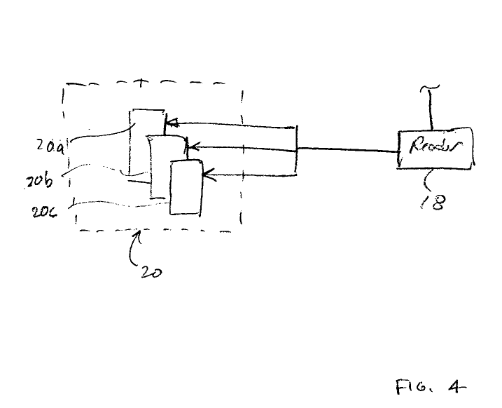

Referring to FIG. 4, one exemplary embodiment of the reader 18 has the capability to query and read the tag assembly 20 (e.g., tags 20a, 20b, and 20c), view data from tags, write tag data, clear tag data, and view signal device and alarm data for tags (as applicable). Several readers 18 can be connected on a single network.

The preferred system uses an Intermec ITRF91501 reader, which is a 915 MHz fixed reader and tag writer having four (4) address antenna ports, an RS232 serial port, and has the capability of reading a tag within twelve milliseconds and performing a verified write at an average of 31 milliseconds per byte per tag. Such a device reads at a distance of about 3 meters with a single antenna.

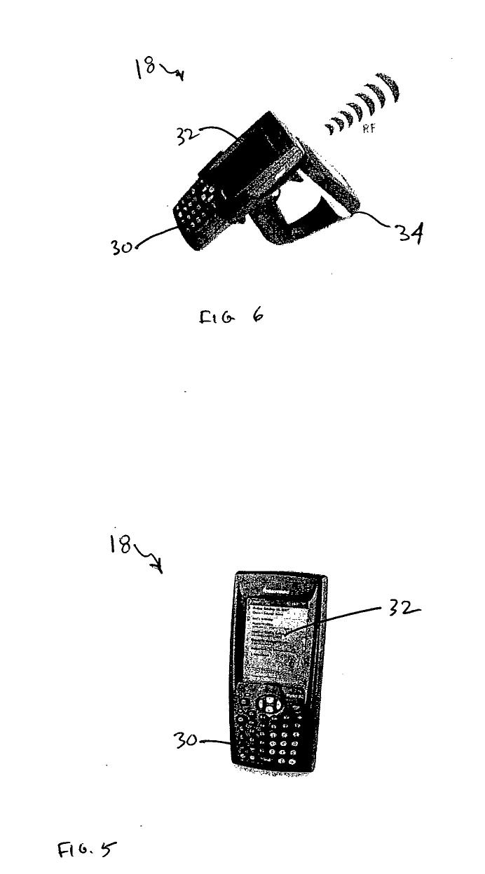

Alternatively, the reader 18 may be an Intermec IP3 portable reader used by personnel at a remote location. Referring now to FIGS. 5 and 6, the Intermec IP3 has mobile read/write capability and includes an Intermec 700 series mobile computer. Reading operations are effected by an internal circularly polarized antenna powered by a rechargeable lithium ion battery pack, and the computer powers the system application to process the RFID tag data. An alphanumeric keypad 30 and a screen 32 facilitate input/output communication from and to a user. The portable reader is built for indoor and outdoor use and has an operating temperature of +14° to +140° F., is rain- and dust resistant, IP64 compliant, powered by lithium ion 7.2 volt batteries, and uses Microsoft Windows for Pocket PC as an operating system. There is either 64 megabytes or 128 megabytes of random access memory (RAM) and flash read only memory (ROM) of 32 megabytes. The internal slots have a secure digital and a compact flash (CF) Type II card. It relies on a standard communication protocol of RS232, IrDA1.1 (115 kilobytes per second (KBPS)). Ten (10) base T-Ethernet and USB port configurations of the reader are available. There are integrated radio options and integrated scanner options for the reader as well. Preferably, the reader 18 can be accommodated by a docking station 34 to provide desktop connectivity.

At any time, an authorized user (having a unique user identifier or password and meeting established security requirements) can read a file from the tag assembly 20 using the reader 18. The read data can be used to schedule medications, surgeries or other treatments, examinations and follow-up visits, and the like. In a preferred embodiment of the present invention, the read file can be copied or transferred to a computer or other control device (e.g., a laptop computer, a desktop computer, or a personal digital assistant (PDA)). Details of the read data may be generated, displayed, printed, or transmitted to a central computer for processing. For example, the read data can be displayed at or printed to a nursing station in a hospital for appropriate use by the patient care staff. Furthermore, using reader(s) 18, the tags can be scanned and the results passed to the same device from which data was loaded from to update the information on the tag. Moreover, under a control mechanism (e.g., software), the data read from a tag can be compared to scanned data. Anomalies and discrepancies can also be flagged for investigation. The report may be printed or displayed.

Referring back to FIGS. 1 and 2, the write apparatus 22 is preferably an Intermec PM4I EasyCoder having an EasyLAN 100/10 Base T Internal Ethernet configuration and being operable using IPL Printer Command Language software and an Intermec LabelShop START Label Design and Print package. Such a device has 4 megabytes of Flash ROM and 8 megabytes of SDRAM and operates with an auto-switch power supply of 115/230 volts AC.

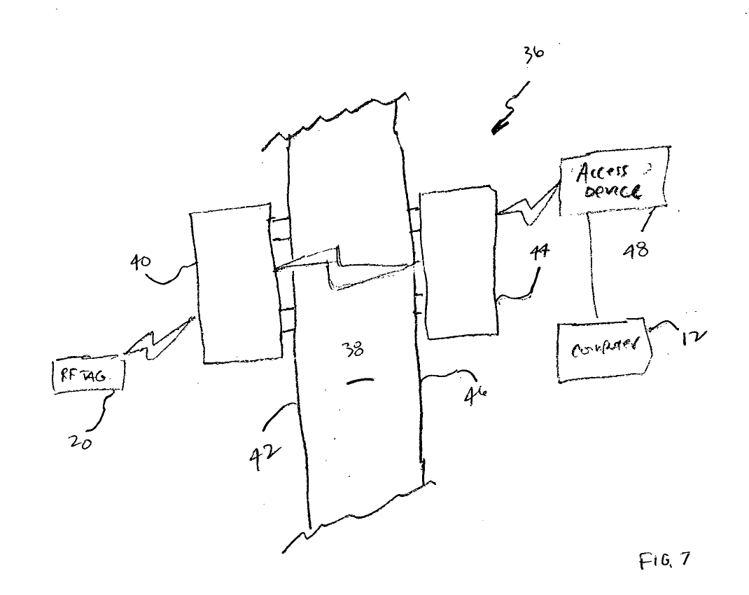

Referring now to FIG. 7, the preferred system also includes a barrier communication system 36 for use in communicating through a wall 38 fabricated of metal or having a quantity of metal sufficient to interfere with the transmission of the radio signals. The barrier communication system 36 comprises a transceiver system capable of maintaining the bi-directional asynchronous transmission of radio signals through metal. The transceiver system comprises dual transceivers, a first transceiver 40 being attached to a first wall surface 42 and a second transceiver 44 being attached to second wall surface 46. The first transceiver 40 and the second transceiver 44 communicate via radio frequency with tags 20 and a remotely positioned reader. Several radio frequency signals may be combined to provide an accurate fingerprint signature of a polled body.

The first transceiver 40 and the second transceiver 44 may be battery powered and have a data communication ability of 100 KBPS. The radio frequency modulation uses amplitude shift keying (ASK), and the device can be used between temperatures from 0° C. to 50° C. Preferably, the transceivers of the barrier communication system 36 are water and dust resistant.

The second transceiver 44 is integratable with a radio access point (RAP) device 48 in communication with the controller 12. The RAP device 48 is a fixed unit that provides for communication ability with the tags. It can be mounted as required in proximity to the second transceiver 44 or remotely therefrom. The RAP device 48 is preferably designed to read up to 1,000 tags in a single read, providing approximately 100 tags in 15 seconds. The device operates at a frequency of about 433.92 MHz. The read range is up to about 30 feet, which is further subject to tag orientation and the presence of metal. Such a device makes it possible to simultaneously monitor large numbers of patients on a wide scale.

The system 10, as described above with reference to FIGS. 1 to 7, is configured to be computer controllable via the controller 12 to collect the data. It easily connects to a PC data control system through a high performance Ethernet network interface cable.

The electronic machines of the system described above are capable of inputting, processing, storing, and transmitting data pertaining to tagged individuals and linking such data to various terminals via the execution of various algorithms as are described hereinafter. The data may also be adapted to be cross-referenced with existing databases to provide functions that track the movement of individuals during movement. The system itself can be read-only or write-enabled to allow for varying degrees of security. An external storage device (e.g., a CD ROM or the like) can be utilized to provide the necessary readouts.

The system provides for the non-intrusive, remote, wireless tracking of patients between destinations in a hospital environment or prisoners in an institution while optimizing the efficiency with which the patients or prisoners are treated or processed, namely, limiting and preferably eliminating the opportunity for misdiagnoses, the administering of wrong treatments, escapes, and the like, thereby reducing the opportunity for mistakes and/or security breaches to occur. The use of the two-way RF transmission technology allows for maximum system integrity to determine pertinent parameters of the treatment process. The transmission of the data may be integrated via satellite, GPRS (general packet radio service), or cellular applications to provide real-time or near real-time analysis.

The system can be adapted for use with any aggregation of tagging arrangements. For example, the system can be adapted for use with individual patients, rooms of patients, wards of patients, cell blocks of patients or inmates, or larger aggregations of individuals. In any arrangement or nesting of arrangements, characteristic signatures are generated by the RFID tag devices. Depending upon the actual nesting of arrangements (e.g., patients in a ward and wards in a building), different tiers are formed. Each tier has a characteristic signature that can be electronically polled at any time to verify the presence of individuals. The electronic polling provides for an interrogation of the any individual or aggregation of tags by relying on changes in a magnetic field flux. The second (or subsequent) tiers of any arrangement include the contents of multiple congregations of individuals or multiple groups of individuals. The characteristic signature of each tier can be combined to produce an aggregate signature that is characteristic of any portion of the total number of tiers. A total aggregate signature should properly correspond with an overall characteristic signature of the largest tier. A comparison of a reading of the total aggregate signature with a stored signature should result in the same value. Any deviation between the signatures is indicative of the presence of extra individual (if that individual is tagged) or the absence of an authorized individual.

The signatures, either individually or aggregations thereof, are recorded and can be provided to the requisite agencies as needed and in response to conformance with the proper protocol. Such government agencies may then have the option of interrogating the tags, reading the radio frequency identification, and generating a real-time signature at any time.

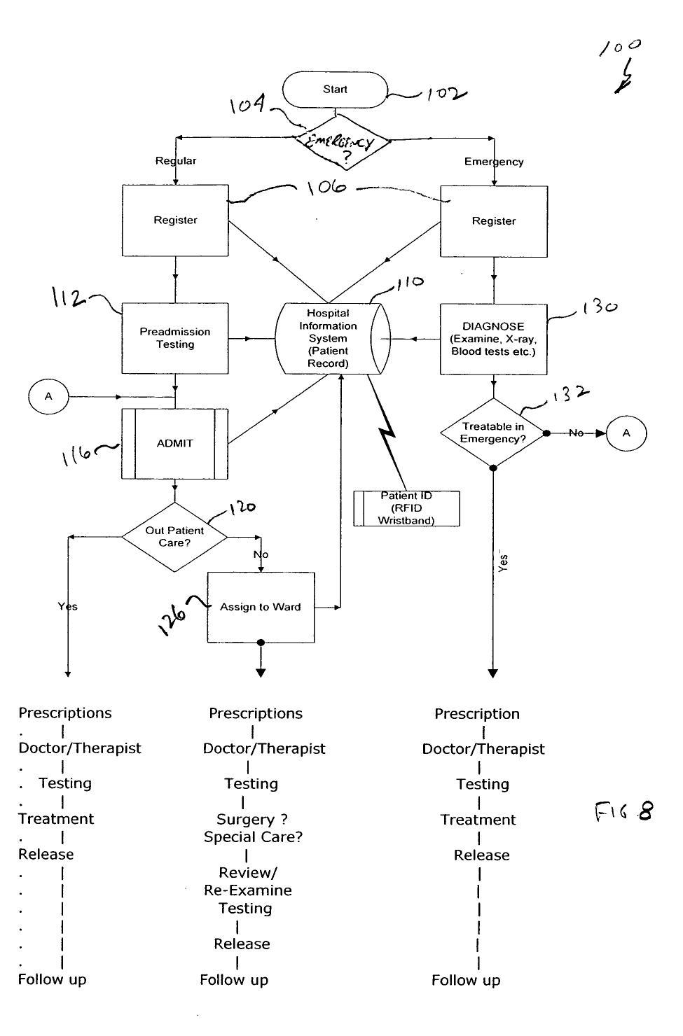

Referring to FIG. 8, a general overview of a patient care system using RFID is shown at 100 and is referred to as “system 100.” Upon initiation of the system 100 at an initiation step 102, a query 104 is made to determine if an individual (e.g., a patient) is an emergency case or a non-emergency case. In either the emergency- or the non-emergency case, the patient is registered in a registration step 106. Information is transmitted to a hospital information system 110 to create a patient record.

In the non-emergency case, after the registration step 106 the patient undergoes a preadmission testing procedure 112. After the preadmission testing procedure 112, the patient is admitted in an admission step 116. Upon completion of or during both the preadmission testing procedure 112 and the admission step 116, the hospital information system 110 is updated.

Once the patient is admitted, a query 120 as to the type of care to be received is made. In the query 120, a determination as to whether the patient will receive outpatient care or inpatient care is made. In the case of the patient receiving outpatient care, information indicative of prescriptions required, doctors and therapists providing treatment, testing and treatment procedures, release procedures, follow up procedures, and the like is written to the hospital information system 110 and copied to the tag (which is preferably incorporated into a wristband secured to the patient) as necessary. In the case of the patient receiving inpatient care, a location assignment step 126 is executed in which the patient is assigned to a particular location (e.g., a wing, a ward, a room, a bed, or the like). Information indicative of prescriptions required, doctors and therapists providing treatment, surgeries performed or to be performed, special care requirements, review/reexam procedures, testing and treatment procedures, release procedures, follow up procedures and the like is then written to the hospital information system 110 and copied to the wristband as necessary.

From the query 104 in the emergency case (and after the registration step 106), the patient undergoes a diagnosis step 130 in which the patient is examined, X-rayed, and tested as required. Tests that may be performed include, but are not limited to, blood typing tests, virus screenings, vital sign screenings, and the like. Relevant data is written to the hospital information system 110 and copied to the wristband as necessary. A query 132 is then executed to determine whether the patient is treatable as an emergency. If the patient is not treatable as an emergency, he is admitted in the admission step 116 and accordingly treated. If the patient is treatable as an emergency case, then he receives the pertinent treatment and information indicative of prescriptions required, doctors and therapists providing treatment, surgeries performed or to be performed, special care requirements, review/reexam procedures, testing and treatment procedures, release procedures, follow up procedures and the like is then written to the hospital information system 110 and copied to the wristband as necessary.

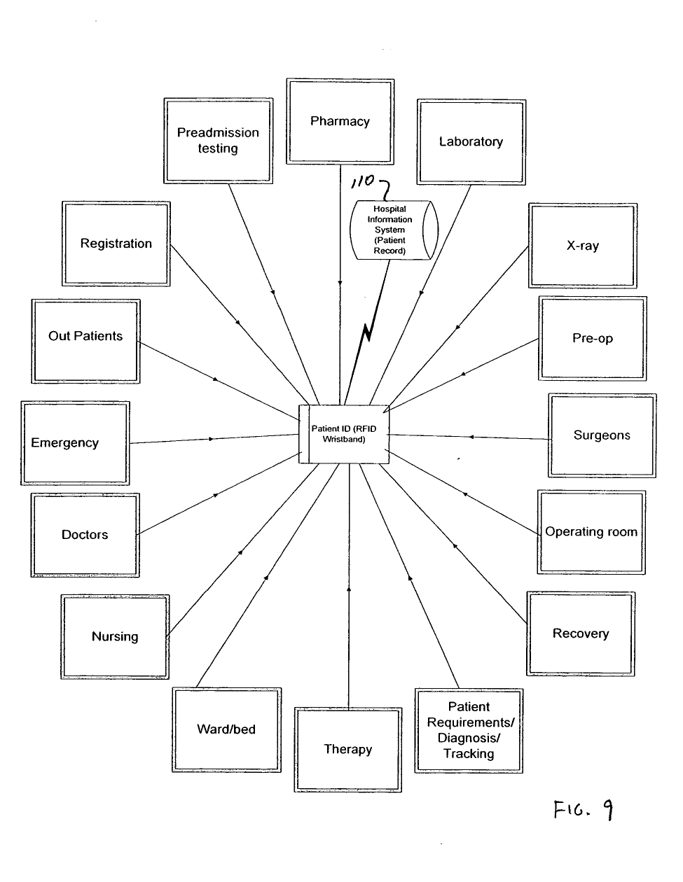

Referring now to FIG. 9, a partial list of the various parameters writable to the wristband and communicable with the hospital information system 110 are illustrated. Parameters writable to the wristband include pharmacy and prescription information, preadmission testing data, registration information, outpatient/inpatient status, emergency status, doctor data, surgeon data, nurse data and other nursing information, ward/bed information, therapy data, patient requirements (e.g., special dietary requirements, laundry requirements, blood types, drug allergies, and the like) as well as diagnoses and tracking information, recovery procedures, operating room data and procedures, pre-operation information, X-ray data and results, laboratory test data and results, and the like.

All RFID fields and related data, as described with regard to the devices and procedures outlined above and particularly with regard to the procedures of FIGS. 8 and 9, conform to the standards and regulations for tamper-proof, non-transferable, positive patient identification as defined by the Health Insurance Portability and Accountability Act (HIPAA), the Joint Commission of Accreditation of Health Care Organizations (JCAHO), the American Hospital Association (AHA) guidelines, and all other industry standards requirements.

With regard to patient identification, it should be noted that safety goals put forth by JCAHO require two (2) identifying entities for each patient. The primary identification number for the patient will be that patient's social security number. The secondary identification will be the patient's last name. For patients with no social security number (or if the social security number is not available), a unique identifying number will be generated and used in place of the social security number. If, however, a patient who is admitted with no social security number can be definitely identified in the existing (history) patient medical records database, the social security number (or generated unique patient identification number if no social security number is recorded) will be extracted from the database and used as the patient's primary identification.

If a patient provides a social security number at the time of admittance and an existing patient medical record exists for the same patient but is without a social security number, the existing patient medical record(s) will be updated with the social security number and the social security number will be used as the primary patient identification.

If a patient whose record is identified by a generated unique patient identification number is able to present a social security number at a later time, the patient medical record(s) will be updated in the hospital information system database to include the social security number and the social security number will be used as the primary patient identification and the patient's wristband updated appropriately.

As the patient is moved around the hospital facilities (through admittance, through various departments such as X-ray, emergency, surgery, to a bed in a ward, and the like) the patient's location will be entered into conveniently located workstations and recorded in the patient's RFID wristband and in their patient medical record in the hospital information system database.

When a patient is admitted through the emergency department, he is given an RFID bracelet. The bracelet is updated at each station to identify where in the facility that patient is. The hospital information system then converts that location data into status information. For example, as soon as the patient is picked up in the waiting room, the triage nurse is notified the patient is waiting. Once triage is complete, the charge nurse is notified that a patient is ready to be brought back to the department. As soon as the patient enters a room in the department, the room is reserved for that patient and the doctor and nurse are notified of the patient's arrival. Patient movement triggers all of the notifications.

By combining the information obtained using the devices and procedures described herein with interfaces to admittance-, registration-, laboratory-, radiology-, and bed management systems, RFID identification allows for the control of a hospital facility (or penal institution) in a very efficient manner.

Although this invention has been shown and described with respect to the detailed embodiments thereof, it will be understood by those of skill in the art that various changes may be made and equivalents may be substituted for elements thereof without departing from the scope of the invention. For example, “individuals” as used herein is defined expansively beyond humans to include anything which is capable of unique identification. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

What is claimed is:

1. A tracking system for use in identifying individuals of a group, each of said individuals having an associated data set indicative of the identity of those individuals, said system comprising:
an electromagnetic identification apparatus configured with each of said individuals for providing an electromagnetic identification signal indicative of the content data set of that apparatus;
a writer for use in encoding said electromagnetic identification signal, with signals indicative of said individual onto said electromagnetic identification apparatus;
a controller for receiving said encoded signals for storing said encoding signals in a master database storage apparatus; and
a reader remotely positioned from said controller and configured for communicating with said electromagnetic identification apparatus and receiving said encoded signals therefrom corresponding to said container content data signal set, said reader also for providing said controller with signals indicative of the same.

2. The tracking system of claim 1 further comprising a plurality of said readers placed remote from one another within a limited geographic area, and said controller further comprising a means for generating inquiry signals requesting said encoded signals from each of said electromagnetic identification apparatus.

3. The system of claim 1 wherein said electromagnetic identification apparatus further comprises an RFID tag.

4. The system of claim 3 wherein said reader further comprises means for polling each of said RFID tags within a selected system.

5. The system of claim 3 wherein said controller further comprises a means for manning said reader to generate polling command signals to poll RFID tags within a range of said reader.

6. The system of claim 3 wherein said controller further comprises a means for receiving polled RFID signals from said reader and recording the same in said master database storage apparatus.

7. The system of claim 3 wherein said controller further comprises a means for comparing received polled RFID signals from said reader and comparing them with signals corresponding to an expected set of RFID tag signals.

8. The system of claim 3 further comprising a plurality of readers positioned at select geographic locations wherein said controller further comprises a means for systematically generating polling command signals for polling said RFID tags in range of each of said reader and providing signals and recording the same on said master database storage apparatus.

9. The system of claim 8 wherein said controller further comprises a means for periodically generating said polling command signals for each of said readers.

10. The system of claim 8 wherein reader further comprises a means for providing polled RFID signals from a given RFID tag and storing said signals on said master database storage apparatus with signals indicative of time and place.

11. The system of claim 3 wherein said RFID tag further comprises a means for storing signals identifying specific individual parameters which are time variant.

12. The system of claim 1 wherein said controller further comprises a means for compiling received RFID tag signals stored on said master database storage apparatus and comparing said signals with signals corresponding to a permissioned time and location for each of said RFID tag signals and generating an alarm signal should said received RFID tag signals indicate a variance with permissioned RFID tag signals for each of said readers.

13. The system of claim 1 when said reader comprises an Intermec IP3 portable reader platform.

14. The system of claim 1 further comprising a means for creating from said received electromagnetic identification tag signals that further create:
a first tier aggregate signature corresponding to signals indicative of a select set of electromagnetic identification tags in an assembly;
a means for storing said first aggregate signature signals in a said master database storage apparatus; and
a means for receiving and modifying command signals for creating a second tier aggregate signal corresponding to a modified set of electromagnetic identification tags in range of a select reader.

15. The system of claim 14, further comprising a means for comparing stored aggregate signature signals with currently received aggregate signature signals.

16. The system of claim 15, further comprising a means for generating an alarm signal should said comparison indicate a discrepancy between the signals associated with said stored aggregate signature signals and the signals comprising said currently received aggregate signature signals.

17. The system of claim 1, further comprising a transceiver apparatus having first and second components adapted to be respectively placed on opposing sides of a wall and remaining in mutual electronic communication, said transceiver apparatus for providing electromagnetic identification tag signals through said wall and for providing polling command signals received from said reader through said wall to each of said electromagnetic identification tags.
